(19) United States
(12) Patent Application Publication
(10) Pub. No.: US 2018/0356945 A1
(43) Pub. Date: Dec. 13, 2018

(54) COUNTER-TOP DEVICE AND SERVICES FOR DISPLAYING, NAVIGATING, AND SHARING COLLECTIONS OF MEDIA

(71) Applicant: California Labs, Inc., San Francisco, CA (US)

(72) Inventors: Brian GANNON, San Francisco, CA (US); Ethan BALLWEBER, San Francisco, CA (US); Joseph JOHNSTON, San Francisco, CA (US); Sital MISTRY, San Francisco, CA (US)

(21) Appl. No.: 15/778,596

(22) PCT Filed: Nov. 23, 2016
(86) PCT No.: PCT/US16/63613

§ 371 Date: May 23, 2018

Related U.S. Application Data
(60) Provisional application No. 62/259,275, filed on Nov. 24, 2015.

(51) Int. Cl. G06F 3/0482; G06F 3/0488

(52) U.S. Cl. CPC G06F 3/0482; G06F 3/0362; G06F 3/04883

(57) ABSTRACT

Systems, methods, and machine readable media for implementing a service for displaying, navigating, and sharing collections of media. Additionally provided is a device for use with such services that may receive, navigate, and display collections of media, allowing, for example, local and remote control over screen brightness and navigation through feeds and channels of media.

### RELATED APPLICATIONS

The present application claims the priority benefit of U.S. Provisional Patent Application No. 62/259,275, filed on Nov. 24, 2015, the disclosure of which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent & Trademark Office patent files or records, but otherwise reserves all copyright rights whatsoever. The following notice applies to the drawings that form a part of this document: Copyright 2015, 2016, California Labs Inc., All Rights Reserved.

### FIELD OF THE INVENTION

The present invention relates to apparatuses, systems, computer readable media, and methods for the provision of devices and services concerning displaying, navigating and sharing collections of various types of media.

### BACKGROUND

Consumers frequently generate digital media, including photos and video, but have limited choice in how to display, share, and navigate through large collections of digital media in an efficient and user-friendly manner. Additionally, currently available approaches for viewing and sharing digital media, such as an online photo album on Facebook™ or Flickr™ viewed via a laptop computer, or loading a set of photos onto a digital picture frame, suffer from drawbacks.

For example, viewing a photo album via Facebook™ on a laptop requires a multistep process including turning on the laptop, opening a browser window, logging in, navigating to a photos panel, and possibly additional steps to access the album. This multistep process to view the photos may be difficult for a technologically unsophisticated person to follow, and does not lend itself to a quick and effortless way to view the photos, at least in part because both the laptop and Facebook™ are not physically optimized for a primary purpose of viewing and sharing media items and streams.

Use of a conventional digital picture frame may also have drawbacks as it may require a user to load pictures onto a removable drive using another device, then plug the removable drive into the digital picture frame, and then may either provide cumbersome configuration options or no configuration options at all, for instance if the device automatically displays all the pictures loaded using the removable drive without customization. Such a device may also not support display of video or annotations, or provide the ability to navigate through media on the device or share media to remote users via the device.

There is a need for devices and services that facilitate simple and convenient ways for displaying, navigating, and sharing collections of media, including, for example, always-on, always-cloud-connected devices that facilitate these and additional functions. Disclosed herein are embodiments of an invention that address those needs.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIGS. 1A-1C show overviews of exemplary client devices and user interfaces for the service, in accordance with some embodiments of the invention;

FIGS. 2A-2B show two views of a multifunctional device for use with the service, in accordance with some embodiments of the invention;

FIG. 3 shows a view of a multifunctional device for use with the service, in accordance with some embodiments of the invention;

FIG. 4 is a block diagram showing an exemplary multifunctional device for use with the service, in accordance with some embodiments of the invention;

FIG. 5 is a block diagram showing exemplary data flows for an exemplary system in accordance with some embodiments of the invention;

FIGS. 6A-6D show user interfaces concerning the login and account creation process for an exemplary service in accordance with some embodiments of the invention;

FIGS. 7A-7B show user interfaces concerning the activity feed for an exemplary service in accordance with some embodiments of the invention;

FIGS. 8A-8D show user interfaces concerning a photo sharing process for an exemplary service in accordance with some embodiments of the invention;

FIGS. 9A-9C show user interfaces and a process involving notifications regarding photo sharing for an exemplary service in accordance with some embodiments of the invention;

FIG. 10 shows a user interfaces concerning remote control of a multifunctional device in accordance with some embodiments of the invention;

FIGS. 11A-11D show user interfaces and a process concerning creation of channels for an exemplary service in accordance with some embodiments of the invention;

FIGS. 12A-12H show user interfaces and a process concerning the configuration of a multifunctional device in accordance with some embodiments of the invention;

FIGS. 13A-13C show views, user interfaces of a multifunctional device, and a process concerning videoconferencing, in accordance with some embodiments of the invention;

FIG. 14 is a block diagram showing an exemplary computing device, consistent with some embodiments of the invention;

FIG. 15 is a block diagram showing an exemplary computing system, consistent with some embodiments of the invention;

FIGS. 16A-16B show diagrams concerning capacitive touch sensing, consistent with some embodiments of the invention;

FIGS. 17A-17B show diagrams concerning resistive touch sensing, consistent with some embodiments of the invention;

FIG. 18 is a diagram concerning inductive touch sensing, consistent with some embodiments of the invention.

### DETAILED DESCRIPTION

Disclosed herein are devices, systems, methods, and machine readable media for implementing and using a service for displaying, navigating, and sharing collections of media. For example, in one embodiment, a multifunctional device of the invention may be placed on a counter top, may automatically be powered on during set periods of each day, and may display a series of photos that were directed to the device by a friend of the device's owner, where the photos are sourced from a photo album associated with the friend's third party social media account.

As used herein, a “multifunctional device” refers to a portable device for displaying, navigating, and sharing media items, that may be placed on a surface (e.g., a kitchen counter or desk). Some embodiments of the multifunctional device are optimized for this purpose by limiting the user interface for the device to controls designed specifically for navigating and interacting with media items—for example, using a physical dial for navigating between media items in a channel, and using a physical knob for navigating between channels. Additionally, some devices use a touch-sensitive surface, gesture, and/or voice commands that are also optimized for navigating and interacting with media items. As a platform, the device maintains its focused purpose by allowing display and interaction with channels, as opposed to applications, because a focus on channels causes the device to function in a more predictable, consistent way. Because the device is not designed to be operated as a general-purpose computer, it is simpler and easier to use for its intended purpose by technologically unsophisticated users, by casual users or users who use the device as “background” or ambient entertainment, and by users who are multitasking (e.g., cooking or working).

As used herein, “media” refers to audible and/or visually perceptible content that is encoded in any machine-readable format such that it can be heard and/or viewed by a human being when presented by the multifunctional device of the present invention. Examples of media include digital images, digital videos/movies, and digital audio, including streaming video and audio. A “media item” is a single media document (e.g., an image, such as a JPG, GIF, or PNG document, or a movie, such as an AVI, MOV, or MP4 document), often referred to as a “file”, or a media stream (e.g., an audio and/or video feed). Media and media items may be associated with a variety if use cases, such as video conferences, photo sharing, audio/video playback (as occurs when watching movies, television programs, or listening to music, etc.), message playback, viewing live streamed audio/video presentations, whether homemade or commercially produced, for example from web cams, commercial sources, public access sources, etc., and so on. In various use cases, sources of media items used by the present multifunctional device include, but are not limited to, photo and/or video sharing websites, such as Instagram™, YouTube™, etc., streaming cameras, such as Dropcams™, etc., social media websites and services, such as Facebook™ Live, streaming media and video on demand sources, such as Netflix™, etc., and “smart” or “connected” home devices and appliances, such as Ring™ doorbells and cameras, and Nest™ thermometers/thermostats/smoke detectors, etc. Other examples of media and media item sources are described below. Media and media items may also, in some cases, refer to user interfaces and associated user interface screens (or similar control interfaces) for “smart” or “connected” home appliances or controls, such as thermostats, smoke/carbon monoxide detectors, etc., home appliances, home lighting, access, and/or environmental equipment, electronic equipment, computer networking equipment, and other, similar devices. For example, the multifunctional device of the present invention may serve as a convenient access point for controlling, configuring, and/or querying such appliances or equipment via application programming interfaces or user interfaces provided by same. In such instances, channels (discussed further below) of the multifunctional device could be used in lieu of individual, device-specific interfaces, providing a single point of control for a “smart home”.

As used herein, a “channel” refers to a feed of one or more media items arranged in a sequence. In certain embodiments, media items in the channel are arranged by a preference such as date/time created or popularity. In certain embodiments, the feed represents a defined list or grouping of two or more items, or a stream of items that is updated at regular or intermittent time intervals. In certain embodiments, the feed is an audio and/or video stream, such as a videoconferencing or audio conferencing stream. A user may navigate forward or backward among the media items in the channel. In cases where channels are configured to provide access to smart home appliances or similar devices, the channels would facilitate the display of user interface screens of the respective appliances (e.g., via native user interfaces presented via the multifunction device and/or apps running thereon).

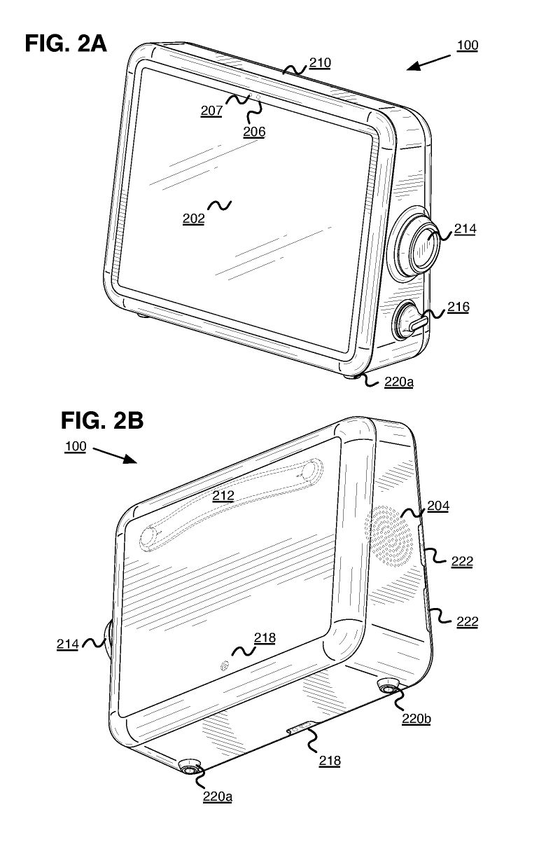

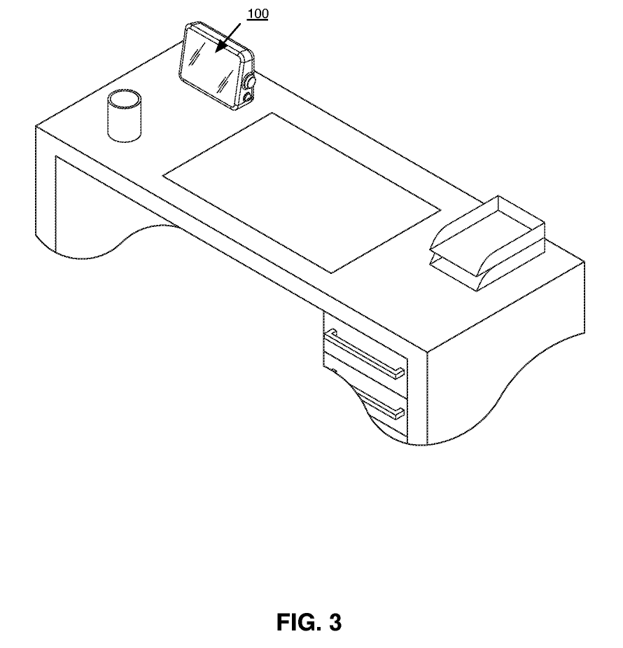

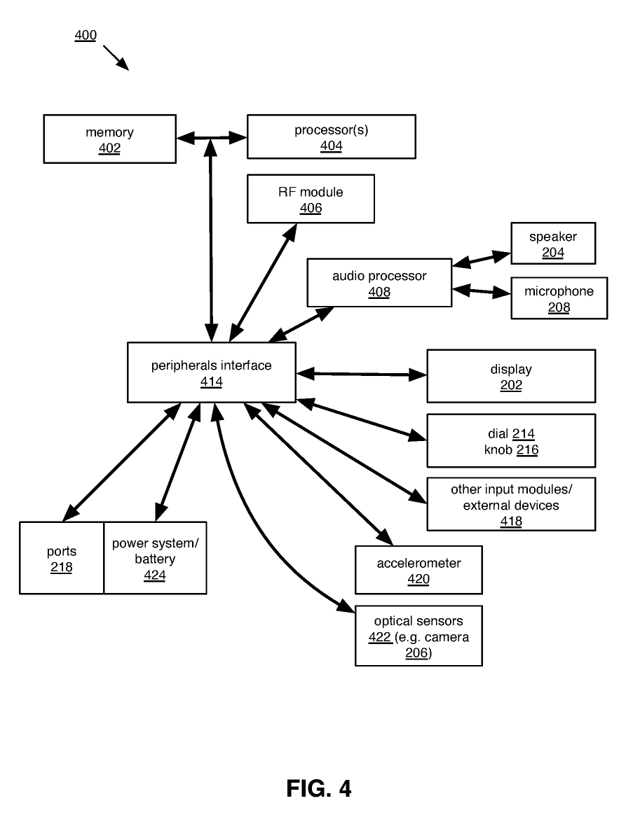

“Channelizing” media in accordance with the present invention frees users from the sometimes difficult task of manually navigating, e.g., using a web browser or other “player”, to different media sources and selectively playing content from those sources. Instead, users are provided a familiar paradigm, akin to changing channels on a radio or television, through which they can access such media sources, even if they do not know or cannot remember the unique addresses associated with those sources. Through the channel creation process, users can create channels once, store them in a channel list of their multifunctional device, and thereafter “tune” to the channel for media simply by rotating knob 216 (see FIG. 2A). One tuned to a channel, different media items can be viewed by turning dial 214. Users can create channels for their own enjoyment, for sharing with friends and family, or for sharing with the public (or defined segments thereof). For example, once created, a channel can be published to selected multifunctional devices much in the same way an Internet URL or other unique identifier can be shared with others, or a channel can be published to a publicly accessible list maintained by the service described herein for use by others. Subscribing to a channel is accomplished simply by saving the unique identifier associated with same to a channel list maintained by a multifunctional device. Thereafter, manipulating knob 216 will cause feeds associated with channels to be accessed according to the rotary positon of knob 216 with respect to an arbitrary start positon. When knob 216 rotated to a particular position, a pointer index to the channel list is incremented to the associated channel unique identifier in the channel list, the identifier is retrieved from memory and used by processor 404 (see FIG. 4) to cause an application program 1504a-1504y (see FIG. 15) to access a media source at the address specified by the unique identifier, download, and “play” the first media item from that source. Other media items may be played in succession, either automatically or manually, as specified by rotations of dial 214.

In instances where a channel is associated with a “smart” appliance or the like, tuning to the channel causes the multifunctional device to communicate (e.g., over a LAN or an ad-hoc point-to-point network) with the appliance and present the appliance's user interface, command line interface, or other control interface on the display 202. Alternatively, tuning to the appliance's channel may cause an app to launch at the multifunctional device through which data extraction, command entries, and other interaction with the appliance may be facilitated. Alphanumeric entries from the multifunctional device can be made via a virtual keyboard displayed on the multifunctional device, as is known in the art.

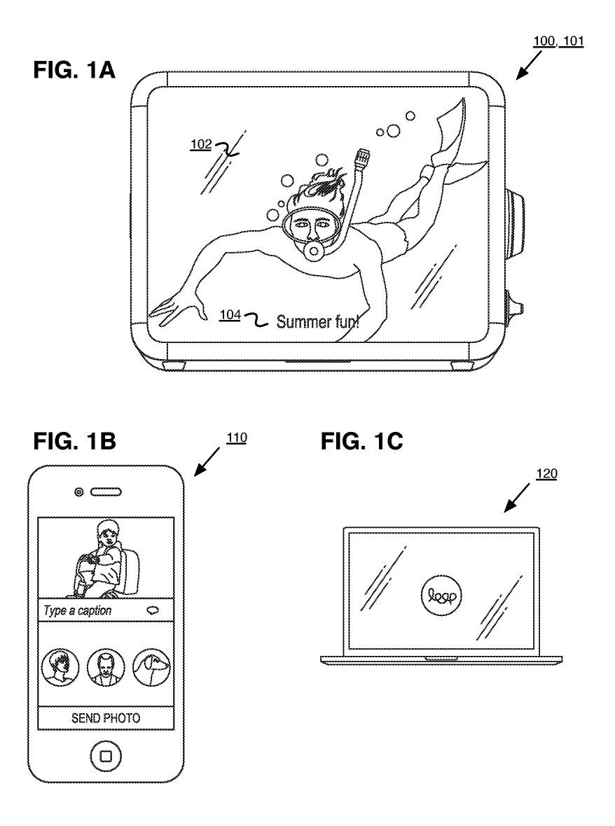

FIGS. 1A-1C show overviews of exemplary client devices and user interfaces for at least one service contemplated by the invention. FIG. 1A depicts exemplary multifunctional device 100, which may be a counter-top device for viewing and interacting with media via the service. Device 100 is associated with the exemplary user interface (UI) 101 as shown in FIG. 1A, which includes both features displayed on the screen, i.e., media item 102, here, a photo of a snorkeling person, and associated caption 104, stating “Summer fun!”. Captions may be short messages that are associated with a particular media item. Exemplary user interface 101 may include additional features to enable user interaction, such as the dial and knob and touch-sensitive surface discussed below. FIG. 1B depicts a mobile client 110 for interacting with the service and multifunctional device 100. FIG. 1C depicts a web browser-based client 120 for interacting with the service and other clients such as device 100 and mobile client 110.

FIGS. 2A-2B show two exemplary views of a multifunctional device for use with at least one service contemplated by the invention. FIG. 2A shows a front perspective view and FIG. 2B shows a back perspective view of multifunctional device 100. Device 100 includes screen 202. In certain embodiments, the screen may be a 10-inch Retina™ or other high resolution screen, such as a screen having 200, 300, 400, or 500 pixels per inch. In certain embodiments, the screen is touch-sensitive and responds to touch-based gestures. In other embodiments, the screen is not touch-sensitive. Also shown is speaker 204 for audio output. In some embodiments, speaker 204 is located on the side, the back, the top, or the bottom of device 100. Device 100 may include a microphone 208 (see FIG. 4) for collecting audio input, and a camera 206 for recording images and video. Device 100 may further include a light sensor 207 for detecting ambient light levels. Device 100 may also include a touch-sensitive surface 210 on one or more regions of its casing, including the top of the device as shown in FIG. 2A. The touch-sensitive surface 210 may detect gestures such as taps, directional swipes, etc., and may distinguish between multiple levels of touch-based pressure or force. The touch-sensitive surface 210 may be dynamically segmented into regions associated with one or more particular functionalities based on the current state of the user interface associated with device 100. (For example, the left half of surface 110 may respond to a tap with function A, such as displaying the previous media item 102, and the right half of surface 110 may respond to a tap with function B, such as displaying the next media item 102, when device 100 is being used to view a channel of media items one item at a time.) Device 100 may include a strap 212 for convenience in lifting the device. In certain embodiments, the device may include a handle or a grip.

Device 100 includes, as part of its user interface, a large rotating dial 214 and a small rotating knob 216. Dial 214 and knob 216 may be linked to different functions at different states of operation of device 100—for example, in a default state of operation, dial 214 may cycle through digital media files or other media items 102, and knob 216 may be used to browse channels. In one embodiment, dial 214 has a greater number of detents per complete revolution than does knob 216. For example, dial 214 may have imperceptible detents or 100 detents per 360-degree revolution, whereas knob 216 may have 12 detents per 360-degree revolution. In certain embodiments, dial 214 is optimized for navigating through a large sequence of items or options at a greater rate, whereas knob 216 is optimized for selecting between a smaller number of options by way of a smaller number of distinct detents as the knob is rotated. In one embodiment, the speed of rotation of dial 214 may affect the corresponding selection of items or options, such that rotating the dial at a high speed causes the selection to scan through a larger number of items than rotation through the same number of degrees at a lower speed of angular rotation. In another state of operation, dial 214 may be used to pan or zoom within a media item 102, or adjust contrast (or other attribute) in a photo, or perform another operation. Cycling through media items 102 may mean loading the next photo in a channel of photos. Dial 214 may cycle forward (load next) or backward (load previous) through a collection of photos depending on the direction the knob is turned (clockwise or counter-clockwise). The browsing operation of knob 216 may operate in a similar matter based on the direction the knob is turned—rotating clockwise may select the next channel and rotating counter-clockwise may select the previous channel in a group of channels. Device 100 may include just one knob or dial, or more than two dials/knobs, such as three, four, or five dials and/or knobs. Device 100 may also include buttons, switches, and other types of input controls. In some embodiments, dials or knobs may also function as buttons (e.g., they may be pressed to activate a function). In some embodiments, knobs may be touch sensitive—e.g., simply touching or tapping a knob may “wake” device 100 (e.g., cause the device to resume operation from a state in which the device consumes little power and provides no display), may cycle forward or backward through a channel, or may activate an indicator light or illumination of the dials, knobs and/or switches available on device 100. In one embodiment, one tap of dial 214 advances a channel to display the next media item 102 on screen 202, and two taps of dial 214 rewinds the channel to display the previous media item 102.

Device 100 may include one or more ports 218 for, e.g., powering or charging device 100, or for receiving data. In certain embodiments, device 100 may include additional controls, such as a dimmer control for manual control of the brightness of screen 202. In some embodiments, the dimmer control is a rotatable knob. Device 100 may include two or more feet 220. Each foot 220 may be adjustable, such that it may be used to control the vertical angle of screen 202. In certain embodiments, device 100 may include physical controls 222 for, e.g., providing a binary user input to device 100, e.g., to toggle device 100 on or off. In certain embodiments, one or more physical controls 222 may provide a slider for scalar user input, e.g., to modulate audio volume when device 100 is used to play a media item 102 associated with audio.

FIG. 3 shows an exemplary view of multifunctional device 100 positioned on a desk. In certain embodiments, multifunctional device 100 may be positioned on any reasonably level surface such as a shelf or a counter. In certain embodiments, device 100 may be affixed to a wall. In certain embodiments, one or more rooms of a dwelling may be associated with a dedicated multifunctional device 100. For example, each of a kitchen, office, living room, or bedroom may include a dedicated multifunctional device 100, and in certain embodiments such a dedicated multifunctional device 100 may be adapted or optimized to allow user interaction with content or functionality that is most relevant to that room.

FIG. 4 is a block diagram representing an exemplary multifunctional device 400 for use with the service. Device 400 may include more components or fewer components than device 100. The device 400 may have a memory 402 which may include one or more types of computer readable media, such as volatile and/or non-volatile memory or other storage devices. Memory 402 may store an operating system, applications, and communication procedures. Device 400 may include one or more data processors, image processors, or central processing units 404. Device 400 may include a peripherals interface 414 coupled to RF module 406, audio processor 408, display 202 (in some embodiments, a touch sensitive display), dial 214, knob 216, other input modules/devices 418, accelerometer 420 and optical sensor 422. Peripherals interface 414 may be coupled to additional sensors, such as sensors associated with one or more touch-sensitive surfaces 210.

RF module 406 may include a cellular radio, Bluetooth radio, NFC radio, WLAN radio, GPS receiver, and antennas used by each for transmitting and/or receiving data over various networks.

Audio processor 408 may be coupled to a speaker 204 and microphone 208. Display 202 may receive touch-based input. Other input modules or devices 418 may include, for example, a stylus, voice recognition via microphone 208, or an external keyboard.

Accelerometer 420 may be capable of detecting changes in orientation of the device, or movements due to the gait of a user. Optical sensor 422 may sense ambient light conditions, and/or acquire still images and video (e.g., as with camera 206 and light sensor 207; in certain embodiments, camera 206 and light sensor 207 are the same sensor, and in others, the functionality is provided via two or more separate sensors). In some embodiments, optical sensor 422 may function as a movement detector.

Device 400 may include a power system and battery 424 for providing power to the various components. The power system/battery 424 may include a power management system, one or more power sources such as a battery and recharging system, alternating current (AC), a power status indicator, and the like. Device 400 may additionally include one or more ports 218 to receive data and/or power, such as a Universal Serial Bus (USB) port, a microUSB port, a Lightning™ port, a Secure Digital (SD) Memory Card port, and the like.

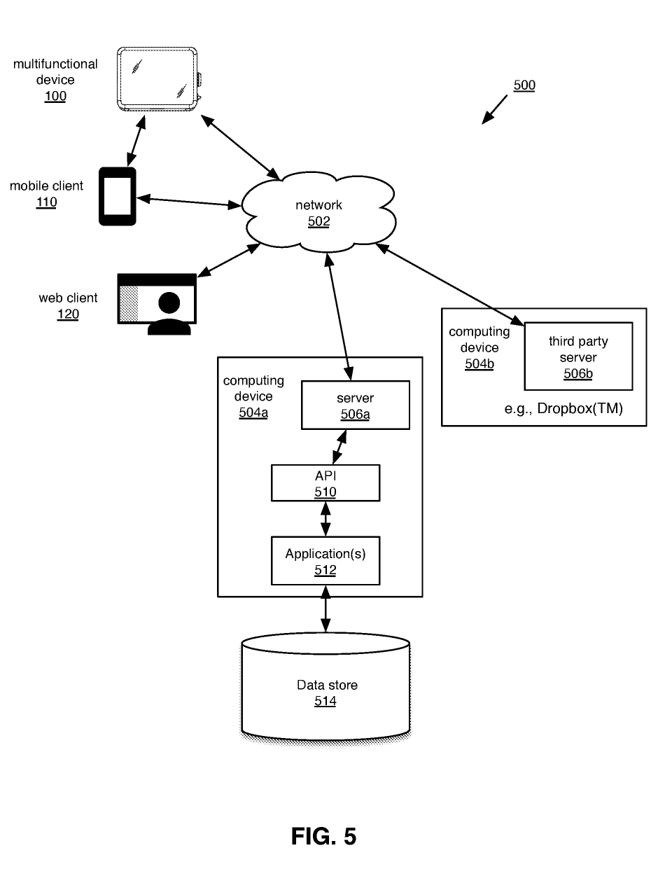

FIG. 5 is a block diagram showing exemplary data flows for an exemplary system 500 in accordance with some embodiments of the invention. In certain embodiments, the photos that may viewed by clients of the system may be stored local to multifunctional device 100, mobile client 110, or web client 120. Mobile client 110 may be resident on mobile devices such as a tablet or smart phone. Web client 120 may be a laptop or desktop computer. In certain embodiments, the client devices may provide data to computing device 504a via network 502. Network 502 may include a local area network (LAN), wired or wireless network, private or public network, or the Internet.

In certain embodiments, one or more computing devices 504a hosts a server 506a, such as an HTTP server, and an application 512 that implements aspects of the service. Media files and/or user account information may be stored in data store 514. Application 512 may support an Application Programming Interface (API) 510 providing external access to methods for accessing data store 514. In certain embodiments, client applications running on client devices 100, 110, and 120 may access API 510 via server 506a using protocols such as HTTP or FTP.

In certain embodiments, client devices 100, 110, and 120 may receive media files from third party services such as Dropbox™, Instagram™, Google Photos™, Facebook™, and Flickr™. These media files may be accessed by connecting to the corresponding third party server 506b.

In certain embodiments, web client 120 may be used to create a new user account, accept an invite to share/access another user's device 100, provide and send photos using the service (for example, upload photos from local storage to server 506a/data store 514), or view and manage existing photos on a device 100.

In certain embodiments, device 100 may be used to ambiently enjoy photos and video, and to interact with the media (e.g., acknowledging a new photo, navigate to the previous or next photo).

In certain embodiments, mobile client 110 may be used to take and send new media items 102 such as photos; view and manage existing photos on the device 100; view media feeds or channels; control the device 100 as a remote or change the settings of device 100; configure a new device 100 and manage the new device and account settings; and create a new user account.

In certain embodiments, a mobile device may be used to generate a media item 102, such as a photo. Using a mobile client 110 hosted by the mobile device, a user may associate the photo with a channel of the service, and upload the photo to, e.g., server 506a via network 502. The server may optimize the uploaded photo for distribution as an item in the channel by, for example, creating additional versions of the photo intended for display via the channel as viewed on particular types of devices (e.g., the server may create a thumbnail version for display as one of many items in a single view on a device, a high-resolution version for viewing on a multifunctional device 100, a smaller version for view on low-capability mobile devices, and the like). Next, clients at the devices that subscribe to the channel (e.g., multifunctional device 100, mobile client 110, web client 120) will fetch the appropriate image for display (e.g., the thumbnail version and/or a larger version sized appropriately based on the capabilities of the display on the host device).

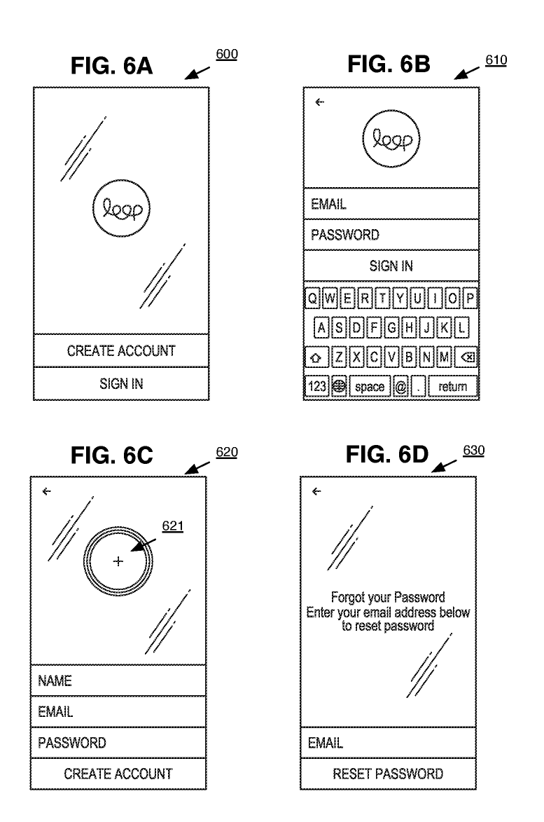

FIGS. 6A-6D show exemplary images concerning a login and account creation process for one embodiment of the service. FIG. 6A shows a user interface (UI) 600 for creating a new account or signing in to an existing account. A user may provide an email and password for an existing account (UI 610, FIG. 6B) or may create an account by entering those items as well as a name (UI 620, FIG. 6C). As part of creating a user account, a new user may use an add-photo control 621 to associate a user photo 622 with the account. In certain embodiments, a user account may be associated with one or more devices for accessing the service, wherein the devices may be mobile devices, multifunctional devices 100, and the like. In certain embodiments, a user may specifically configure his or her experience of the service for mobile devices in general. In certain embodiments, a user may specifically configure his or her experience of the service individually for one or more multifunctional devices 100, such that each multifunctional device 100 presents a particular set of channels and modes of viewing the channels. In certain embodiments, the service automatically customizes the user experience for a particular multifunctional device 100, e.g., using machine learning techniques or based on the user's past behavior with that particular device 100. A user may reset the user's password by way of UI 630 in FIG. 6D.

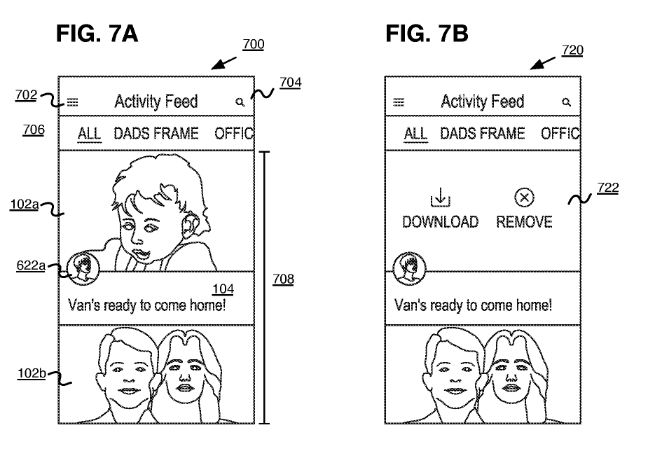

FIGS. 7A-7B show exemplary UIs concerning the activity feed for one embodiment of the service that may be viewed using a mobile device, such as via mobile client 110. An activity feed may be a stream of media items (e.g., photos and videos) displayed in series, along with comments 104 on the media items that may be associated with an author and time stamp, as shown in exemplary UI 700 in FIG. 7A. The activity feed may comprise media items associated with each multifunctional device 100 that the user has access to—e.g., one or more channels of content. When viewed on the multifunctional device 100, in some embodiments, comments may be overlaid on the associated media item as shown in FIG. 1A, with a comment shown as caption 104. Exemplary UI 700 includes a navigation panel access control 702, which upon selection presents the user with a navigation panel, a search control 704 for receiving search queries, and a feed selector 706. UI 700 further presents the activity feed content in feed panel 708. Individual media items may be associated with the user who created or submitted the media item, as expressed via user photo 622a that is associated with media item 102a. FIG. 7B shows exemplary UI 720, which may be accessed by selecting a media item 102 from UI 700. Accordingly, in some embodiments, a media item in the feed panel 708 may be selected (e.g. by clicking with a mouse, tapping on a touch-sensitive screen, or hovering with a mouse), and then the media item 102 may be downloaded or removed from the feed (and/or the device 100) as desired using media item controls 722. As shown in FIGS. 7A-7B, an activity feed may be an aggregated feed of multiple streams of media. A user may select “all” in feed selector 706 to view the aggregated feed, or may select a subsidiary feed such as “Dad's Frame” or “Office” to view just the media items in the subsidiary feed. In some embodiments, each subsidiary feed may encompass the media items associated with a single device 100.

An activity feed may provide a visual indicator of all of the photos stored on a device 100, allowing management of those photos (or other types of media items 102). An activity feed may also allow the one or more users sending photos to a device 100 to see what has been sent to the device 100. This may function as a private social network for users with access to a particular device 100.

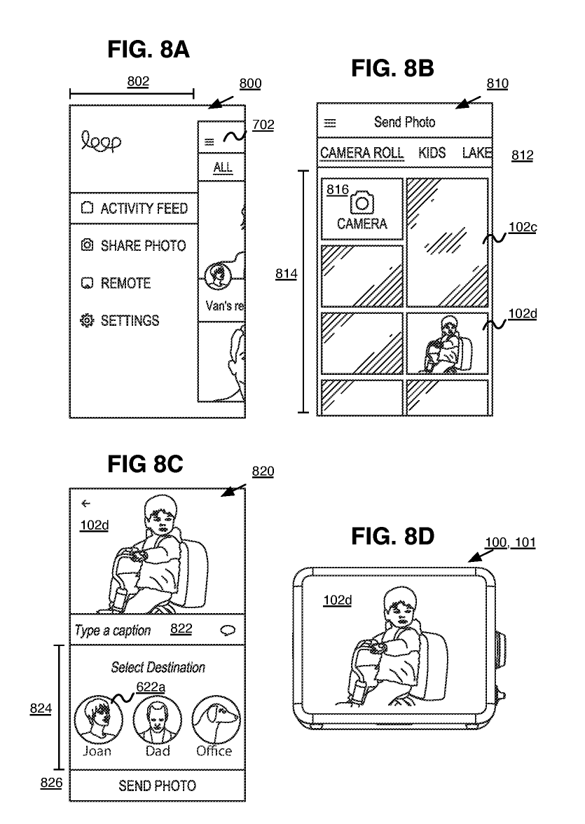

FIGS. 8A-8D show exemplary UIs concerning a photo sharing process for one embodiment of the service. In UI 800 shown in FIG. 8A, a user may select the “share photo” option from a menu of options in navigation panel 802. A user may access navigation panel 802 by selecting navigation panel access control 702, e.g., from UI 700. Selecting “activity feed” in navigation panel 802 may access a UI such as UI 700. Selecting “share photo” brings the user to, e.g., exemplary UI 810 for selecting content. UI 810 includes content category selector 812, for displaying representations of the media items falling into the selected content category in media listing panel 814. Content categories may indicate various sources or types of media items, for example photo albums, items tagged with a particular term, or items sourced from a particular device or third party service. Exemplary UI 810 shows a camera roll showing available media items 102 for sharing, selectable via media listing panel 814 (FIG. 8B). UI 810 also may provide access to categories of media items, such as photo albums or folders or other collections of media. In certain embodiments, the user may select a camera option 816 to take a photo using the current client device. Once the user selects or takes a photo, the user is presented with the UI of FIG. 8C. In FIG. 8C, the user may select one or more destinations from a list of destinations for the photo (or other media item 102). Available destinations may be other users (e.g., Joan, Dad) or particular devices 100 where the photo may be sent (e.g., “Office” for a device 100 that may be located in the user's own home). In certain embodiments, if a user is selected as a destination (e.g., by selecting the user represented by user photo 622a in UI 820, “Joan”), the media item is made accessible to the user at all clients associated with the user via the service, e.g., a one or more of multifunctional device 100, mobile client 110, and web client 120. The user may also provide a caption for the photo (e.g., caption 104) at caption field 822, or edit an existing caption. In certain embodiments, the user may edit the media item—for example, the user may pinch/zoom to resize and crop the photo as desired. Once the destination is selected, the user may cause the photo to be made available at the selected destination(s) by selecting a “send photo” control 826. As indicated in FIG. 8D, showing another view of UI 101 displaying media item 102d, the sent media item 102 will be automatically retrieved by the selected device where it may be displayed and otherwise interacted with. UI 101 may characterize a state of a mode for selecting and viewing media items in a channel at device 100 in which, for example, rotating dial 214 may select the next or previous media item for view in a channel.

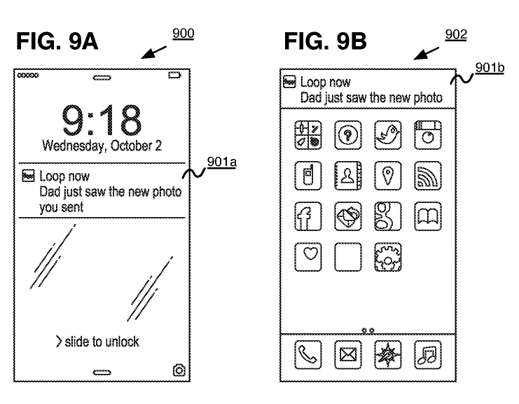

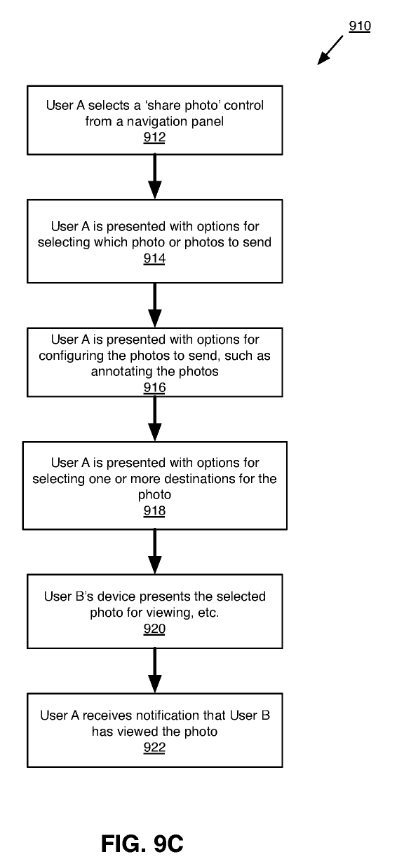

FIGS. 9A-9B show exemplary images concerning notifications regarding photo sharing for one embodiment of the service. As shown in FIGS. 9A and 9B, showing UIs 900 and 902, in certain embodiments the user who sent the media item may receive a notification 901 at, e.g., mobile client 110 indicating that the user associated with a selected destination has viewed the media item. A notification 901 may be shown on the lock screen of a mobile client (e.g., 901a) or as a badge, sound, banner (901b), or alert on a mobile client or multifunctional device 100. In certain embodiments, when a media item 102 is sent to a particular device 100, the media item is stored on device 100, and when the destination user turns dial 214, or knob 216, causing the media item to be displayed on screen 202, a notification 901 is provided to the sender (e.g. at mobile client 110 for the sending user). Such a notification may state, for example, “Dad just saw the new photo you sent”, or “Mom saw your picture!”. A notification 901 may also be provided when a destination user acknowledges the sent media item—e.g., when the destination user taps the top of a device 100 (at a touch-sensitive surface 210) to “like” a new photo, the sender may receive a corresponding notification 901 that “Mom saw your picture” or “Mom likes your picture”.

FIG. 9C shows process 910 concerning sharing a media item 102. To begin, a first user at, for example, a mobile client 110 selects an option to share a media item 102, e.g. as shown with exemplary UI 802 (step 912). In certain embodiments, step 912 and one or more of the following steps may be performed at a web client 120 or a multifunctional device 100. Upon selecting the “share” option, the first user is presented with various controls and options for selecting the media items to send, e.g., via exemplary UI 810 (step 914). In certain embodiments, the selectable media items are stored local to the user, e.g., on a mobile device or multifunctional device 100. In certain embodiments, the selectable media items are hosted by a third party at a remote server. The first user may additionally configure the selected media items, for example by adding captions, resizing or cropping the media items, or applying a digital filter to create a different appearance for the items (step 916). The first user may additionally provide a single or multiple destinations for the selected items (step 918). Destinations may be set according to a category (e.g., “family members”, in which all users who are defined as family relative to the first user and the corresponding devices are selected upon selection of the “family members” category) that represent multiple users, a single user and corresponding devices 100, and/or particular multifunctional devices 100 (e.g., “kitchen” or “family room”). Upon selection of content to send and configuration of that content, each destination device will be notified regarding the available content. The notified devices will accordingly download the selected media items from a server of the service and present the media items locally (step 920). When a second user views the selected media items, the first user may receive a notification 901 regarding that event (e.g., that one or more of the selected media items was viewed, and by whom) (step 922). In certain embodiments, such a notification 901 will indicate the device on which the media item was viewed (e.g., “John viewed your photo on the Kitchen device.”).

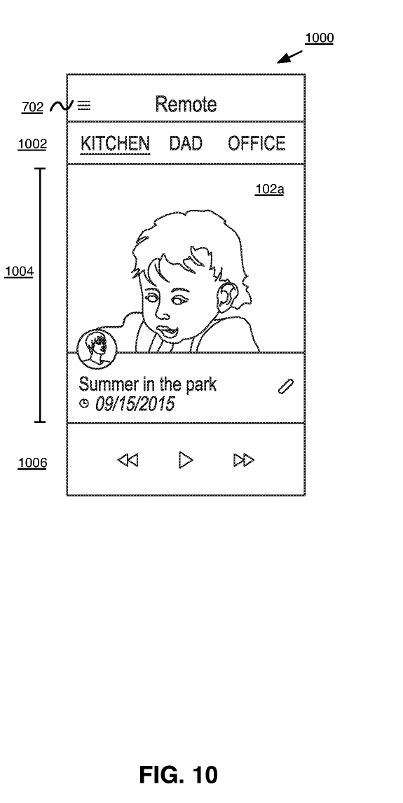

FIG. 10 shows an exemplary UI 1000 concerning remote control of a multifunctional device 100 for one embodiment of the service. In certain embodiments, a “remote” UI 1000 allows users to control any of their devices 100 with a slideshow-type controller viewed at a mobile client 110. A user may select a device 100 using the menu along the top of the UI (device selector 1002), and swipe through photos or use the controls at the base of the UI (media play controls 1006) to advance to the next media item 102 or return to the previous photo. Such a UI may complement controls on the device 100 itself. The UI of FIG. 10 may also be used to initiate video playback. In certain embodiments, display panel 1004 mirrors the currently displayed media item on the selected device 100 (in FIG. 10, the selected device is “kitchen”), including displaying captions 104. In certain embodiments, display panel 1004 provides additional information relative to the display on device 100, such as a time stamp and an indication of the user who created or posted the media item. In certain embodiments, display panel 1004 provides access to editing tools for cropping, retitling/captioning or otherwise editing the current media item (as shown, media item 102a).

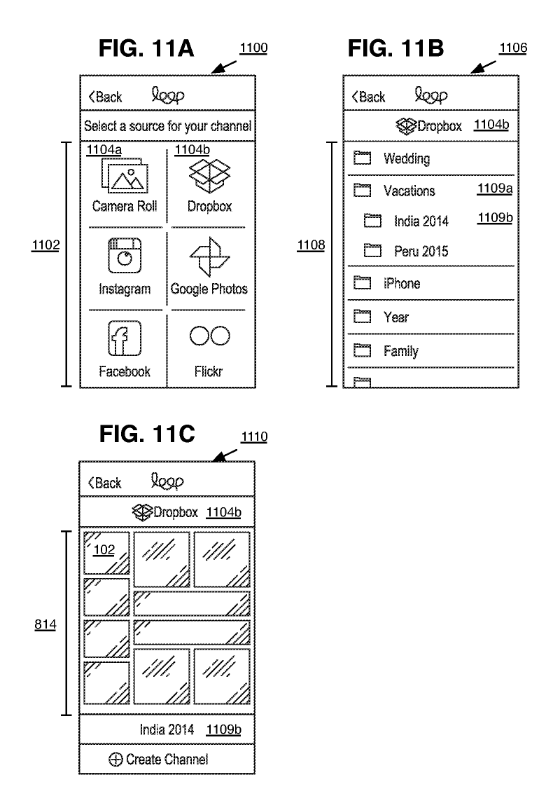

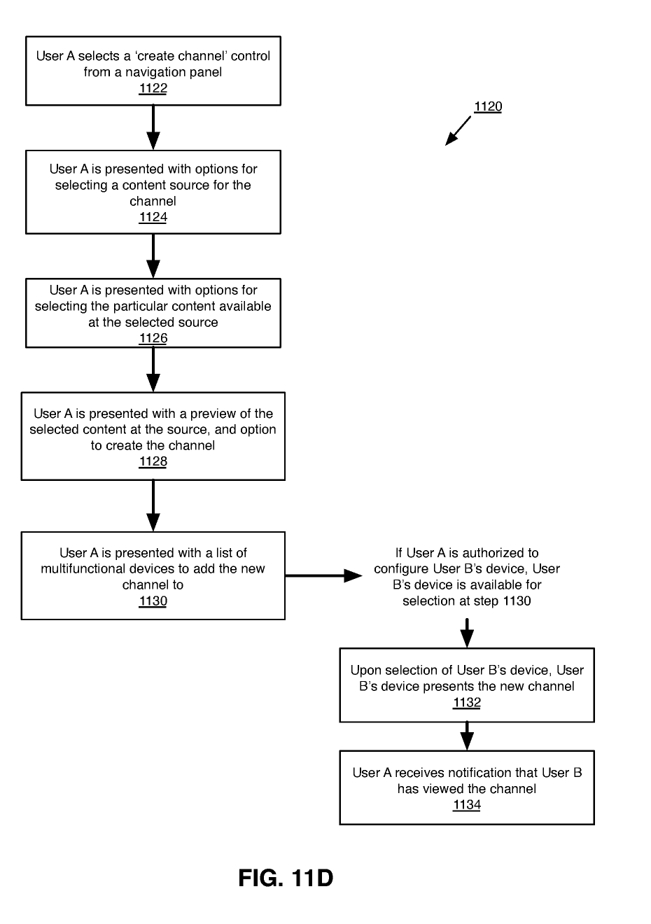

FIGS. 11A-11C show exemplary images concerning creation of channels for one embodiment of the service. Channels may provide a way for users to connect a device 100 or other client device to different content sources, and to organize media into different contexts. In certain embodiments, channels may be created from a mobile client, the UI of device 100, or web client 120. As shown in exemplary UI 1100 in FIG. 11A, to create a channel, a user may select a source 1104 (e.g., an online third party source of media, such as Dropbox™, Instagram™, Google Photos™, Facebook™, and Flickr™) as shown in source selection panel 1102. Once a source 1104 is selected, the user may select a category or album of content located at the source (UI 1106, FIG. 11B). In certain embodiments, content (i.e., media items) available at a source may be arranged into content categories 1109, as showed in content category selection panel 1108. Such categories may be hierarchical (e.g., folders or albums), or may be represented as tags. In certain embodiments, content categories may be selected according to a pre-defined search (such as a search for “cat videos” in YouTube™) or a hashtag on Instagram™ or Twitter™. All or a portion of the selected content may be displayed in a UI as shown in FIG. 11C (exemplary UI 1110), showing media listing panel 814, by which the user is asked to confirm creation of a channel based on the selected content.

FIG. 11D describes an exemplary process 1120 concerning channel creation. A first user may be responsible for creating a channel by initiating the process upon selection of a control element in a UI at a mobile client 110, multifunctional device 100, or web client 120 (step 1122). The first user may then select a source 1104 for the media items 102 to populate the channel, which may be a local directory containing media items (e.g., camera roll source 1104a) or a third party service (e.g., Dropbox™ as a source 1104b) (step 1124, UI 1100). Next, the first user may select a content category 1109 of media items 102 available at the source (step 1126, UI 1106). The first user may then be presented with a preview of the media items corresponding to the selected content category (step 1128, UI 1110), or a preview of all media items available at the selected source. In certain embodiments, the first user may select individual media items such as photos from a media listing panel 814 to populate a new channel. In certain embodiments, the first user may then select a destination for the channel, e.g., via a destination selector 824 (step 1130). Upon such selection, the channel is created by associating the selected media items from the selected source with a unique identifier and the newly created channel is published to the selected destinations (e.g., multifunctional devices 100).

At the multifunctional device, notification of the new channel is received and the new channel is added to a channel list maintained by the multifunctional device. “Tuning” to the new channel is performed through manipulation of knob 216. When so tuned, the processor of the multifunctional device causes the source associated with the new channel to be accessed (e.g., by causing a web browser application running on the multifunctional device to access the channel's unique identifier), and the first media item to be downloaded and displayed. Thereafter, successive media items of the channel will be downloaded and displayed in succession. Or, if the associated media is an audio-video presentation, the presentation will be played. If the associated media item is a live stream, the stream will be played, etc.

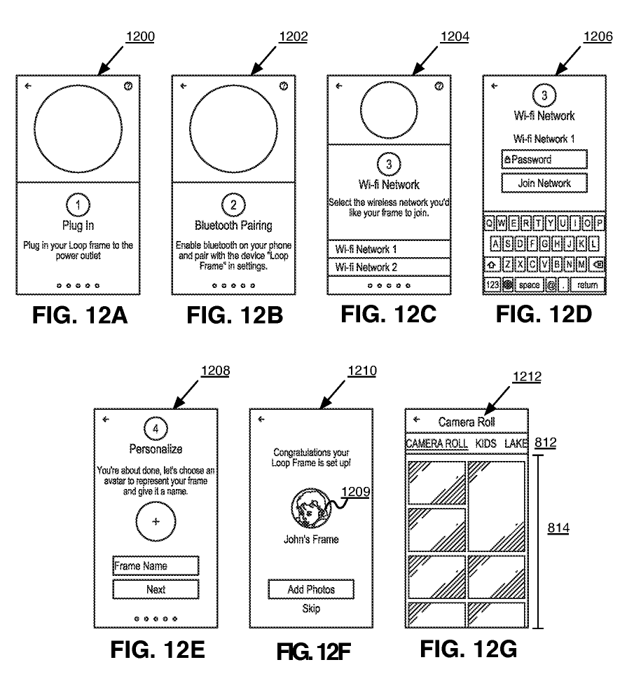

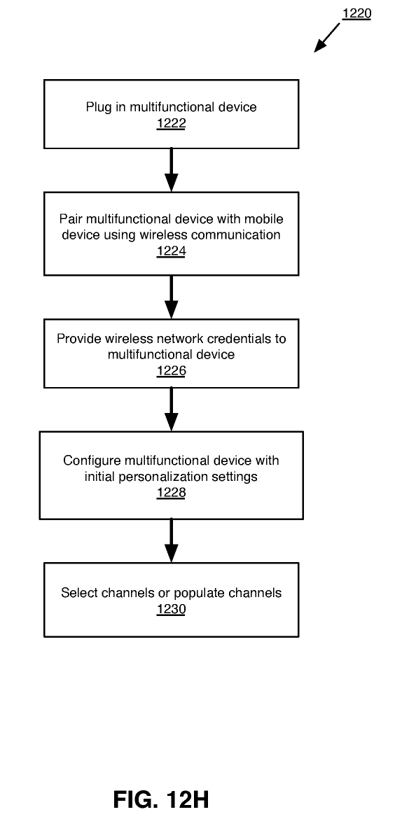

In certain embodiments, the default may be to associate the new channel with the first user and all of the devices associated with the first user. In certain embodiments, if the first user has access to a second user's device, a second user's device may appear as an option in the destination selector 824 of step 1130, such that the first user may create a channel for display on a second user's device 100b, and accordingly the second user's device 100 may obtain access to the channel (e.g., by navigating to the channel using knob 216) without further action from the second user (step 1132). In certain embodiments, during the initial configuration of the second user's device 100b (see below in relation to FIG. 12), one or more secondary users may be authorized to create channels for the device 100b in addition to the second user who is the primary user of the device. Such an arrangement may be useful where the second user encourages receipt of new channels, e.g., a parent or grandparent who is interested in receiving a channel of media items from secondary user who is a child or grandchild. In certain embodiments, during the initial configuration of the primary user's device, secondary users may be granted authorization to remotely configure other aspects of the device in addition to creating channels, or access particular types of channels, such as channels involving video generated by the device (e.g. for use during a videoconference or as a monitor). In certain embodiments, the first time the second user navigates to the new channel, a notification 901 may be sent to the first user to indicate that the second user has viewed the new channel (step 1134). In certain embodiments, a notification 901 will be sent to the first user each time the second user (primary user) views a new media item 102 created by the first user (secondary user) within the channel.

A user may subscribe to channels based on various categories—for example, channels based on media from particular people (e.g., sister, brother, son); channels based on or contributed to by groups of people (e.g., family, Facebook™ feed, a shared Dropbox folder, items from a Pinterest™ page); and channels based on a user's interests or mood (e.g., cars, waterfalls, zen, fireplace, surf, aquarium, space). The knob 216 of device 100 may be used to browse between channels that a user has subscribed to. For example, a user may subscribe to a channel for particular use cases to enhance the environment of a particular location or event (Christmas party, spa/massage therapy room). A channel may represent a particular interest—e.g., it may serve as a snow cam (monitor snow level at ski resorts of interest), surf cam (monitor waves at surfing location of interest). In certain embodiments, a device 100 may subscribe to a particular channel by accessing a uniform resource locator (URL). Channels may be created by commercial entities (e.g., a channel of items available for sale from a clothing brand, or news-oriented photography) or communities that include themed content, such as a pinball enthusiast channel, or a Star Trek™ enthusiast channel. The service may provide access for users to a wide variety of community-curated channels and fee-for-subscription channels. In certain embodiments, community-curated channels may be invite-only, or open to any new user.

In some cases, a channel may be associated with media from a third party service at which the user of a device 100 maintains an account, for example, a service such as Facebook™, or the like. Typically, such accounts require a user to authenticate him/herself to the third party service before access to the media is allowed. While it would be possible to facilitate access via device 100 in such a manner, this would require the user to provide authentication credentials each time s/he tuned to the channel associated with the third party service and defeat the purpose of providing convenient access thereto.

So, to avoid this inconvenience, in an embodiment of the present invention the user's authentication credentials for the third party service are stored, in the form of a token, for use by server 506a. For example, the token may be stored, in form so as to be associated with a user account, in data store 514, and used by server 506 when updating content for a channel and/or when obtaining content to provide to a user's device 100 on behalf of the user. Preferably, the token is stored in a form that is not otherwise readable or useable by anyone other than the user with which the credentials are associated, for example in an encrypted form.

In one example, third party service content may be channelized as follows. Using a device 100 (or mobile client) that is already authenticated to server 506a, a user establishes a connection with the third party service of interest. For example, the user may launch a browser at device 100 and navigate to a portal associated with the third party service or, in some cases, a pre-established channel for the third party service may be exist but need personalization so that it is populated with the user's individual content. Using the existing portal facilities of the third party service, the user authenticates him/herself to the third party service. At the conclusion of this authentication process, a token (or, in some instances, the user's actual log-in credentials) are delivered to the server 506 and stored so as to be associated with the user's account at the present service. In some cases, the token (or other credentials) are stored in an encrypted fashion. Once logged in to the third party service, the user can designate media items for inclusion in the channel.

Thereafter, when the present service updates the media items associated with the user's account, server 506 uses the token (or other credentials) that were stored during the channel set-up process to access the user's account at the third party service. Once authenticated to the third party service the server 506 can retrieve media items as appropriate. In addition, server 506 may retrieve meta data associated with the media items and use that meta data to organize media items from the third party service and other sources for presentation via device 100. For example, by organizing media items collected from a number of media sources, server 506 can respond to user requests for “Photos from Thanksgiving 2016”, for example. Meta data used for such organizational purposes may include dates and times associated with media items, geographical locations associated with media items, subject matters of media items, and so on.

In certain embodiments, a mobile client 110 or web client 120 may additionally be used to configure settings for a multifunctional device 100. For example, the client may provide a UI for remotely configuring parameters for: screen brightness (e.g., controlling display brightness and how it reacts to ambient light); photo transitions (e.g., controlling the look and timing of photo transitions); captions (e.g., controlling the size and style of the captions); power saving (e.g., causing the device 100 to turn on or off automatically based on time, day of the week, and or the date); reminders (e.g., modifying how the service notifies the user of events such as a new photo being sent to a device 100); manage frames (e.g., adding, removing, renaming, changing sharing for particular devices 100); invite others to share (e.g., invite others from a user's contacts—for example, contacts in a directory stored at the device running mobile client 110—to share to the user's device 100); sign out (e.g., sign out of the user's account with the service). Such remote configuration provides the advantage of one user being able to remotely configure a device 100 located with another user to assist the other user, where the other user may be technologically unsophisticated or less able to handle the configuration. In certain embodiments, users with remote configuration access to a device 100 may be secondary users, as distinguished from a primary user who may own device 100 and may be frequently physically in the same room as the device.

In certain embodiments, screen brightness of the device 100 may be configured to mimic a printed photograph (e.g., the screen brightness adjusts dynamically based on ambient light and turns off in the dark); follow adaptive dimming (e.g., the screen brightness adjusts dynamically based on ambient light); or set a fixed brightness. A UI may permit the user to toggle a power saving mode on or off. A power saving mode for the device 100 may set particular hours for a device 100 to be powered on on weekdays and a different range of hours for the device to be powered on on weekends.

FIGS. 12A-12G show exemplary images concerning initial configuration of a multifunctional device for one embodiment of the service, and FIG. 12H describes a related process 1220. Set up for a device 100 may follow a simplified procedure. A user may be instructed to download a client to a mobile client device 110. When the user selects an option to select a new device from client device 110, the user may be instructed to plug device 100 into a power outlet and turn it on (FIG. 12A, UI 1200 and step 1222). Next, the user may be instructed to enable Bluetooth Pairing on the mobile client device 110, and to select pairing with the device 100 (FIG. 12B, UI 1202 and step 1224). Next, the user may be instructed to provide network credentials (e.g., wireless local area network login information) to be used by device 100 (FIG. 12C, 12D, UI 1204 and 1206). In certain embodiments, a UI presented by device 100 may be used to access a network directly, without performing steps 1224 and 1226. A single device 100 may be provided access to one or more networks. In certain embodiments, upon connecting the device 100 to a network 502, device 100 may be configured to establish initial personalization settings (step 1228), e.g., via a mobile client 110, web client 120, or via user interfaces provided by device 100 itself. For example, the user may be instructed to provide an avatar image (i.e., a device photo 1209) and a name for the device 100 (FIG. 12E, UI 1208). In certain embodiments, as part of step 1228, the device 100 may be associated with one or more primary user accounts (see, e.g., FIGS. 6A-6D and UIs 600, 610, 620, and 630). In certain embodiments, as part of step 1228, the device 100 may be associated with one or more secondary user accounts. For example, a client may provide a user interface to a primary user of device 100 an option to select identifiers for new or existing users and designate them as secondary users having one or more levels of access to configure the primary user's device 100. For example, at one level of access, a secondary user may be able to create a channel and make it available on a primary user's device 100, and at a higher level of access, a secondary user may be able to modify any or all configuration settings of the primary user's device. Initial set up may be completed and followed by selection of media items for the device 100 to display (FIGS. 12F-12G, UIs 1210 and 1212, step 1230). Selection of media items 102 to populate a channel to display on device 100 may proceed using UI 1212, which provides selectable elements for identifying media items such as a content category selector 812 and a media listing panel 814.

In certain embodiments, multifunctional device 100 may be always on and available to display media, including streaming media from another device 100, mobile client 110, or web browser-based client 120 (e.g., serving as a baby monitor or a teleconferencing end point). In certain embodiments, device 100 may display or play media from a connected home, such as playing the audio from a streaming music service (e.g., a Sonos™ audio channel) while displaying the song artist, title, and album on the screen 202. In certain embodiments, UI elements of device 100 may be used to control other connected items in the home, such as a home security system (e.g., set or disable an alarm), play music from a Wi-Fi-enabled stereo, control a thermostat (e.g., select thermostat using knob 216 and adjust temperature setting using dial 214). In certain embodiments, the device 100 may function as an alarm clock, and may gradually increase brightness and play a specified audio channel at a desired wake-up time. In certain embodiments, multifunctional device 100 may present a channel of media items as a slide show, advancing to the next media items at defined time increments, where a default time increment is 5 seconds.

In certain embodiments, tapping the touch-sensitive surface 210 once advances to the next media item, or toggles between play and pause for a video. In certain embodiments, tapping the touch-sensitive surface 210 twice acknowledges a media item (e.g., “likes” or “hearts” a photo). In certain embodiments, particular regions of touch-sensitive surface 210 may be associated with one or more functionalities, such as the navigation and acknowledgement examples provided above. Swiping left or right on the touch-sensitive surface 210 may advance or rewind through a queue/feed/channel of media items. While playing an audio or video item, swiping may adjust volume, or may advance or reverse the time parameter for playback of the item.

In certain embodiments, by default the device 100 displays a photo, and when a user walks toward device 100 and motion is detected by optical sensor 422, the display 202 reacts to the presence of the user: for example, a caption or other metadata may be displayed over the photo. In certain embodiments, if microphone 208 detects no sound for a given increment of time such as 1, 5, 15, or 60 minutes, the room is assumed to be empty and the screen turns black or a power saving mode is activated.

In certain embodiments, video from the camera 206 is processed to determine whether luminescence or average color is rapidly changing, which may indicate that a nearby television is active. If a television is active, device 100 may dim display 202 to limit distraction from device 100.

In certain embodiments, video from the camera 206 is processed to determine whether a user has used a physical gesture to summon a function—for example, a user may move a hand in a swiping motion in front of the camera to request that the next or previous media item in a sequence be displayed. For example, a wave or swipe from left to right may request the previous media item, and a movement from right to left may request the next media item 102 in the current channel. Such gesture recognition will depend on the current state of multifunctional device 100—for example, if device 100 is displaying a video rather than a photo, a swipe right may rewind the video for 10 or 30 seconds rather than displaying the previous media item. Other examples of gestures may implement a toggle control—that is, a particular gesture may control starting and stopping a media item carousel, music/audio, or video, e.g., by raising a hand to start, and raising a hand again to stop. In certain embodiments, device 100 may detect a finger—for example, a straight finger may be tracked to identify locations on screen 202, and a bent finger may be detected as a signal to select a control provided at the identified location.

In certain embodiments, accelerometer data is analyzed to determine if device 100 is being moved or has been picked up; device 100 may automatically wake up display 202 upon detection of such an event. That is, upon receiving input from accelerometer 420 (see FIG. 4), a processor 404 may wake the device 100, 400 from a low power state (e.g., a sleep state). Upon waking, the processor may cause a current media item from a selected channel to be displayed on the display 202. Alternatively, or in addition, the processor may cause the device 100, 400 to wake from the sleep state and display a current media item on the display 202 in response to a gesture or other physical movement detected by camera 206. In this way, media items may be displayed when the device 100, 400 recognizes that a user has entered a room or has otherwise come into close proximity to the device, etc. Such waking from sleep states is generally known in the art and can be implemented, for example, by periodically powering up the processor to poll the camera, the accelerometer, and/or other peripherals for any activation events, or may be implemented by waking the processor in response to an interrupt event representative of an activation event recognized by the camera, the accelerometer, and/or another peripheral.

In certain embodiments, knob 216 and/or dial 214 is touch sensitive. Upon detection that knob 216 has been touched, device 100 may automatically display a UI for channel selection from a list or arrangement of channels. In certain embodiments, the channel selection UI disappears upon failure to detect a touch on knob 216. Knob touch sensitivity may be implemented using touch capacitive sensors on or near knob 216.

In certain embodiments, voice commands received via microphone 208 may be used to navigate through functions of device 100—for example, the command “Hey, Loop, go to the Tahoe channel” may select and play a channel named “Tahoe”, or the command “Hey Loop, create a timer for four minutes” will create a four-minute timer and start a count-down that is displayed on the screen. In certain embodiments, processor 404 is configured to parse such voice commands and initiate an appropriate responsive function, such as the navigation command described here.

In certain embodiments, device 100, or clients 110 and 120 may provide an option to select a photo to order a physical print of the photo. In certain embodiments, device 100, or clients 110 and 120 may provide an option to select a photo to create and send an E-Greeting card to selected recipients.

In certain embodiments, the service may automatically curate photos—for example, a “burst” series of photos or other media items 102, or a period of time associated with an atypically large number of photos during a period of time may be used to suggest an event encompassing those photos, and the event or group of photos may be used to create a feed or a channel. In another example, photos taken using a panorama mode or around the same time as a panorama mode was used may be used to group photos into an event. In other examples, photos may be grouped based on facial recognition, identification of smiling, GPS location, a GPS location different from the GPS location of a user's home, or the number of people in a photograph.

In certain embodiments, mobile client 110 may automatically provide the remote control UI when the mobile client is active mobile client device 110 and a multifunctional device 100 is detected as being near (e.g., with detection based on Bluetooth Low Energy (BTLE) or iBeacon™ protocols).

In certain embodiments, device 100 may be configured to display a Ken Burns image panning and zoom effect starting with a person's face in full view, when a person is present in an image being displayed.

In certain embodiments, the speaker 204 volume automatically adjusts based on ambient noise detected via microphone 208 for video playback (e.g., volume is higher when ambient noise is louder, and volume is lower when ambient noise is quieter).

In certain embodiments, the device 100 may identify the user who is near or operating the device 100 using facial detection via camera 206. Device 100 may use facial detection to select and more prominently surface images containing the faces of the user or users who are near when in a certain mode for displaying images.

In certain embodiments, the rate at which the dial 214 is turned affects the speed at which photos are scrolled across display 202—i.e., a faster turn causes a faster scroll speed (or jumping across tens or hundreds of photos at a time), and a slower turn causes the photos to advance one-at-a-time.

In certain embodiments, image metadata (such as owner, location, date, comments, hashtags, likes) is used to automatically generate channels based on commonalities.

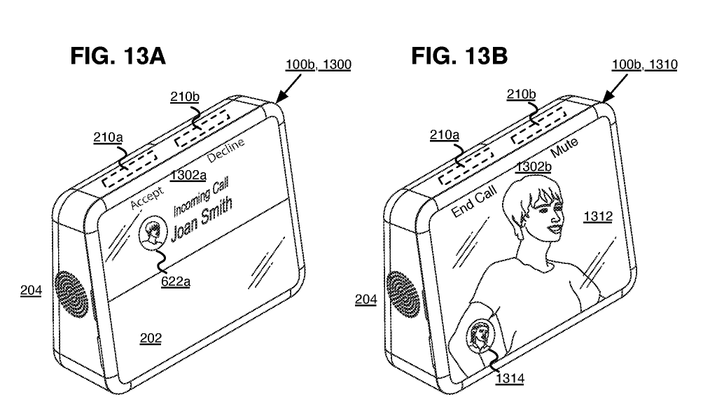

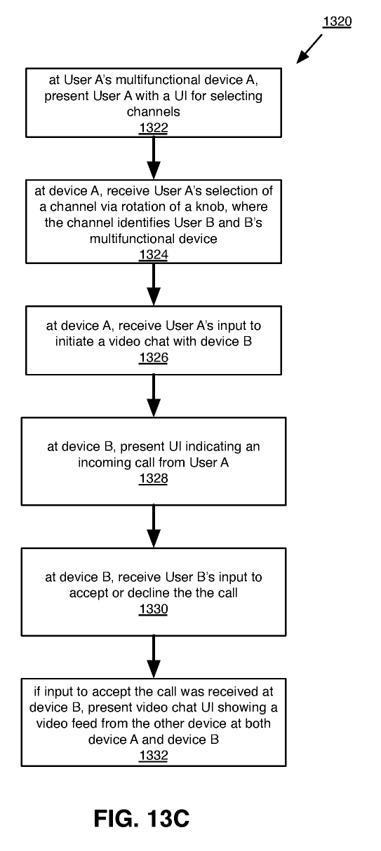

FIGS. 13A-13C include illustrations (FIGS. 13A-13B) and a process 1320 (FIG. 13C) relating to the use of the multifunction device for video conferencing services. For example, in a first step 1322, at a first user's multifunctional device A, the first user may access a UI (not shown) for selecting a channel from a group of channels. Presentation of a UI for selecting channels may characterize a first mode for selecting a channel at device 100. For example, in one embodiment, the channel selection UI may present a list of channel names in a first panel of screen 202, and additional information about the current candidate-for-selection channel in a second panel of screen 202. The first panel may indicate the current candidate-for-selection channel (for example, by highlighting its name in a list, or presenting it in a central location of the first panel), responsive to user interaction with knob 216 (step 1324). The second panel may include, for example, a graphic representing the current candidate-for-selection channel (e.g., an album image that may be representative of the photos and other media items in an album of media items; a user photo 622 that may be representative of a channel of media items associated with that user, or who may be contacted for videoconferencing or audioconferencing from device 100; a device photo 1209 that may be representative of a video feed from another device 100 or webcam, etc. at a particular location such as a video-capable device being used as a baby monitor or pet monitor such that the video feed may be viewed at device 100). The information regarding the current candidate-for-selection channel may also include, for example, the number of media items in an album, a badge indicating the number of new media items added since it was last viewed by the first user or at device 100, the names of users that the channel is shared with, the source of the media items (e.g., Dropbox™), or the type of channel (e.g., album, activity feed, video chat/teleconference). The first user may access the current candidate-for-selection channel to view its contents by, for example, confirming and therefore selecting the channel by an interaction with device 100. In certain embodiments, the first user may confirm selection of the current candidate-for-selection channel by, for example, tapping knob 216 or dial 214, tapping a touch-sensitive surface 210 of device 100 guided by a prompt displayed on screen 202, navigating to a “select” or “view channel” control using dial 214, or the like. For example, in the context of using device 100 for a videoconference, confirmation of the first user's channel selection (where the selected channel identifies a user for a videoconference) may cause device 100 to initiate a video chat with the identified second user (step 1326). In certain embodiments, the second user may be associated in the service with a default video-capable device for a videoconference, such as a second device 100, and the video chat will be initiated by sending a videoconference request with that second device 100. In certain embodiments, an audioconference request will be sent, for example where the second user is not associated with a video-capable device, or where the first user requests an audio-only call.

Referring now to FIGS. 13A-13B, upon receiving a request for a videoconference or audioconference, a second device 100b may provide a UI 1300 for notifying a second user about the request (see FIG. 13A and exemplary UI 1300 of device 100b; and FIG. 13C, step 1326). UI 1300 may include two or more touch-sensitive surfaces 210a, 210b near or adjacent to the screen 202 that may be respectively associated with touch-sensitive surface prompts 1302a displayed on screen 202 for accepting or declining the incoming videoconference request. Touch-sensitive surface prompts may be positioned to guide the user to the appropriate region or touch-sensitive surface for activating a particular function, and both the surface and prompts 1302a may change depending on the state of the device 100b. A tap or press on the appropriate surface will initiate the appropriate response (e.g., commence the video chat or reject the request). UI 1300 may additionally display information about the incoming request—e.g., the name of the first user (“Joan Smith”) and the user photo 622a corresponding to the first user. Device 100b may additionally play a ring sound (or other sound designed to catch the second user's attention) through speaker 204 until the first user cancels the request, the request times out, or the second user accepts or declines the call.

If the second user rejects the videoconference via UI 1300 at device 100b (e.g., by tapping surface 210b), one or both users may be presented with a default UI for device 100, or a “call ended” message, or some other appropriate UI indicating that the teleconference will not be initiated. If the second user accepts the videoconference (e.g., by tapping surface 210a in UI 1300; step 1330), the devices 100 for both the first and second users may present a version of UI 1310, as shown for device 100b (step 1332). UI 1310 may present the videoconferencing feed on screen 202 (e.g., for device 100b), a remote-view video stream 1312 generated by camera 206 at the other device 100 showing the first user, along with a smaller inset local-view video stream 1314 generated by camera 206 at device 100b showing the second user. In certain embodiments, the two video streams 1312 and 1314 are composited into a single video stream for each endpoint device as appropriate by one or more remote computing devices 504. Exemplary UI 1310 additionally provides touch-sensitive surface prompts 1302b, associated with surfaces 210a and 210b for ending the video conference session and muting microphone 208, respectively. In certain embodiments, UI 1310 may provide different or additional prompts such as a volume control, options for configuring the appearance of the displayed video streams 1312 and 1314, such as changing their relative size or hiding the local-view video stream 1314, and the like. In certain embodiments, the volume of the speaker 204 output may be controlled using dial 214.

In certain embodiments, a device 100 may be used as a baby monitor or pet monitor. For example, a first user at a first device 100 may use a channel selection UI (or a corresponding UI at a mobile device 110) to navigate to a “monitor” channel for a particular second device 100. The first user may then view a video feed from camera 206 at the second device. In certain embodiments, the second device screen will stay dark to avoid disturbing the baby or pet at the location of the second device. In certain embodiments, the second device may provide a lit indicator light or indicator UI on screen 202 (e.g., indicating the name of the first user to show that the device is sending video to the first user). In certain embodiments, only primary users or a specific category of authorized secondary users may use a device 100 as a monitor.

Exemplary Procedures for Channel Creation:

(1) From Physical Media

User inserts SD Card. The device 100 auto analyses known file and directory naming structures and EXIF data to create an auto grouping (channel) from this content source correctly attributed (e.g., GoPro, Canon Camera, Nikon Camera), for immediate browsing.

Device remembers previously inserted SD card's contents (last X number), and on insertion can create a channel of just new images added since last insertion. Alternatively, the device 100 can flag and badge new images in an existing channel since the last time the card was inserted.

(2) From Dropbox/Google Drive/Other Cloud Storage Service

In a setup flow, the user connects the cloud storage service via OAuth flow.

Setting up a Dropbox/Google Drive/Other cloud storage service channel:

A. The user clicks the cloud storage service input source in UI in mobile app

B. Mobile app (110) fetches list of the user's cloud storage service folders, examines the contents of each directory searching for ones that contain displayable content, and displays them to the user.

C. The user selects the desired folder(s)

D. The channel is created with contents of the selected folder(s) on the service servers (504a).

E. The user's device 100 receives notification of the new channel creation.

F. The user's device 100 syncs thumbnails of the selected folder(s) contents

G. When the user selects the new channel on the device 100, the device dynamically loads and displays photos and videos from the selected folder(s).

H. When the user adds new photos/videos to the cloud storage service folder, the service servers 504a are notified and, in turn, notify the user's device 100 via push notifications which trigger the device to synchronize its cloud storage service content.

(3) Instagram/Other Photo Sharing Service

A. The user clicks the photo sharing service input source in the mobile app UI.

B. The user searches for photo sharing service friends or enters a hashtag, etc.

C. A channel is created with initial snapshot of contents from friends or hashtag.

D. The user's device 100 receives notification of the new channel creation.

E. The user's device 100 syncs thumbnails of channel contents from the service servers 504a.

F. When the user selects the new channel on the device, the device dynamically loads and displays photos and videos from the photo sharing service.

G. The service servers are notified and notify the user's device 100 when new photo sharing service content is available.

(4) Nest Cam/Other Web Cam

A. The user clicks to add the web cam as a channel in mobile app.

B. The user authenticates access to the web cam token and/or a token embedded link is retrieved from the web cam API.

C. This data is synced to the service servers and sent to user's device 100.

D. When the user navigates to the new channel on the user's device 100, a live feed from web cam is displayed.

Below are set out hardware (e.g., machine) and software architectures that may be deployed in the systems described above, in various example embodiments.

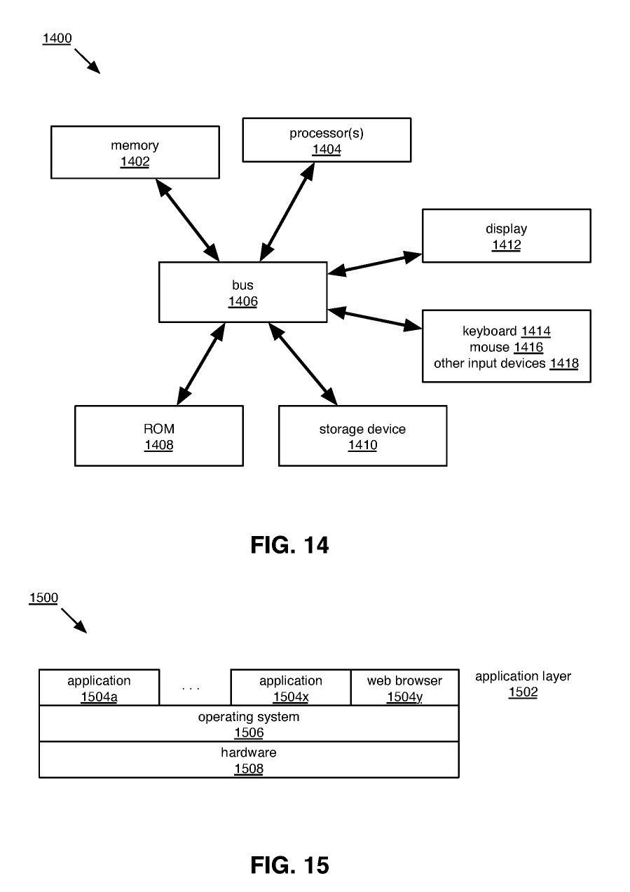

FIG. 14 is a block diagram showing an exemplary computing system 1400 that may be representative any of the computer systems or electronic devices discussed herein. Note, not all of the various computer systems have all of the features of system 1400. For example, systems may not include a display inasmuch as the display function may be provided by a client computer communicatively coupled to the computer system or a display function may be unnecessary.

System 1400 includes a bus 1406 or other communication mechanism for communicating information, and one or more processors 1404 coupled with the bus 1406 for processing information. Computer system 1400 also includes a main memory 1402, such as a random access memory or other dynamic storage device, coupled to the bus 1406 for storing information and instructions to be executed by processor 1404. Main memory 1402 also may be used for storing temporary variables or other intermediate information during execution of instructions to be executed by processor 1404.

System 1400 includes a read only memory 1408 or other static storage device coupled to the bus 1406 for storing static information and instructions for the processor 1404. A storage device 1410, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 1404 can read, is provided and coupled to the bus 1406 for storing information and instructions (e.g., operating systems, applications programs, and the like).

Computer system 1400 may be coupled via the bus 1406 to a display 1412 for displaying information to a computer user. An input device such as keyboard 1414, mouse 1416, or other input devices 1418 may be coupled to the bus 1406 for communicating information and command selections to the processor 1404.

The processes referred to herein may be implemented by processor 1404 executing appropriate sequences of computer-readable instructions contained in main memory 1402. Such instructions may be read into main memory 1402 from another computer-readable medium, such as storage device 1410, and execution of the sequences of instructions contained in the main memory 1402 causes the processor 1404 to perform the associated actions. In alternative embodiments, hard-wired circuitry or firmware-controlled processing units (e.g., field programmable gate arrays) may be used in place of or in combination with processor 1404 and its associated computer software instructions to implement the invention. The computer-readable instructions may be rendered in any computer language. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1400 or similar electronic computing device, that manipulates and transforms data represented as physical (electronic) quantities within its registers and memories into other data similarly represented as physical quantities within its memories or registers or other such information storage, transmission, or display devices.

FIG. 15 illustrates a computer system 1500 from the point of view of its software architecture. Computer system 1500 may be any of the electronic devices or, with appropriate applications comprising a software application layer 1502, may be a computer system for use with the apparatus described herein. The various hardware components of computer system 1500 are represented as a hardware layer 1508. An operating system 1506 abstracts the hardware layer and acts as a host for various applications 1504a-1504x, that run on computer system 1500. The operating system may also host a web browser application 1504y, which may provide access for the user interfaces, etc. described above.

In certain embodiments, the device 100 or other components may incorporate touch sensing technologies, e.g., to enable touch-sensitive surface 210. Such technologies may include one or more of capacitive touch sensing, resistive touch sensing, inductive touch sensing, or other technologies.

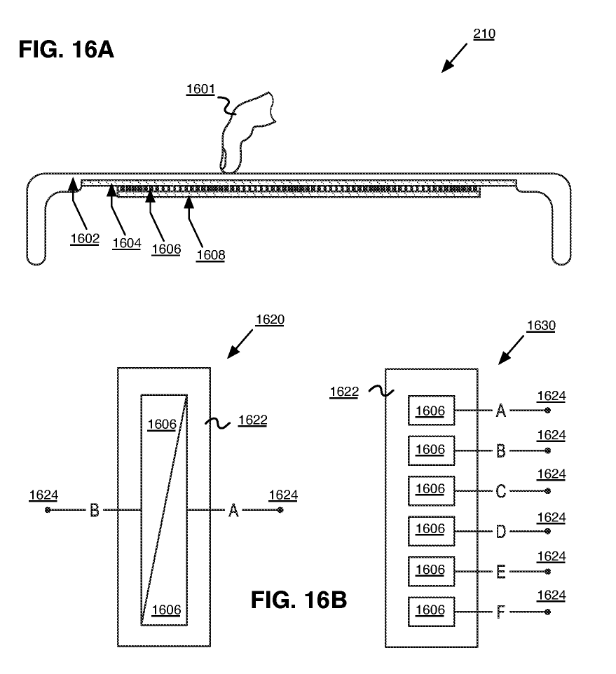

FIGS. 16A-16B show examples of touch sensing surfaces using capacitive touch-sensing technology, consistent with some embodiments of the invention. As illustrated in the example in FIG. 16A, an exemplary touch-sensitive surface 210 may use an electrically conductive contact 1606 and associated sensing circuit to determine a change in sensor capacitance occasioned because of the presence of a human finger 1601. Since this technology determines the existence and location of a touch via a change in sensor capacitance, it does not require measureable force to determine touch and accordingly has the advantage that the associated sensor(s) can be located under a nonconductive material with an external appearance that is unaffected by the presence of the touch-sensitive surface (e.g., non-conductive enclosure 1602, which may be, for example, a plastic housing for multifunctional device 100). In one embodiment for a capacitive touch solution, touch-sensitive surface 210 may include non-conductive enclosure 1602, insulating substrate 1604, conductive contact 1606, and insulating overlay 1608. In certain embodiments, insulating substrate 1604 and insulating overlay 1608 may comprise the same material.

Various implementations of touch-sensitivity are realizable, e.g. for touch-sensitive surface 210 implemented using sensors at a location of the housing of device 100, dial 214, or knob 216. Sensor output may then be processed by processor 404 to cause an appropriate response to detecting a touch interaction at device 100 or 400 from a user. A simple realization for capacitive touch works by using a fixed current source to charge the sensor comprising one or more conductive contacts 1606 over a fixed time interval. The voltage on the sensor at the end of the time interval is affected by the additional capacitance owing to the presence of the human finger. The capacitance of the circuit then determines the amount of voltage read by an analog-to-digital (A/D) converter (not shown).

Various contact configurations are possible. See, e.g., FIG. 16B, showing aspects of two embodiments with different contact configurations (1620 and 1630). In one example (configuration 1620), a linear realization relies on the coupling between two parallel contacts 1606 which is affected by the presence of the human finger. This realization is simple, requiring only a single sensing circuit. As shown, configuration 1620 includes the parallel contacts 1606, a non-conductive substrate 1622, and connections 1624. In certain embodiments, the non-conductive substrate 1622 and one or more of insulating substrate 1604 and insulating overlay 1608 comprise the same material.

Alternatively, in another example (configuration 1630), a series of discrete contacts 1606 are arranged in a sequential fashion. Each contact 1606 is connected (via connections 1624) to a sensing circuit via a multiplexer. The sensing circuit is connected to the contact in a sequential fashion via the multiplexer and the capacitance of the individual contact 1606 is determined. While this implementation consists of discrete sensors, it is possible to determine intermediate finger positions via extrapolation.

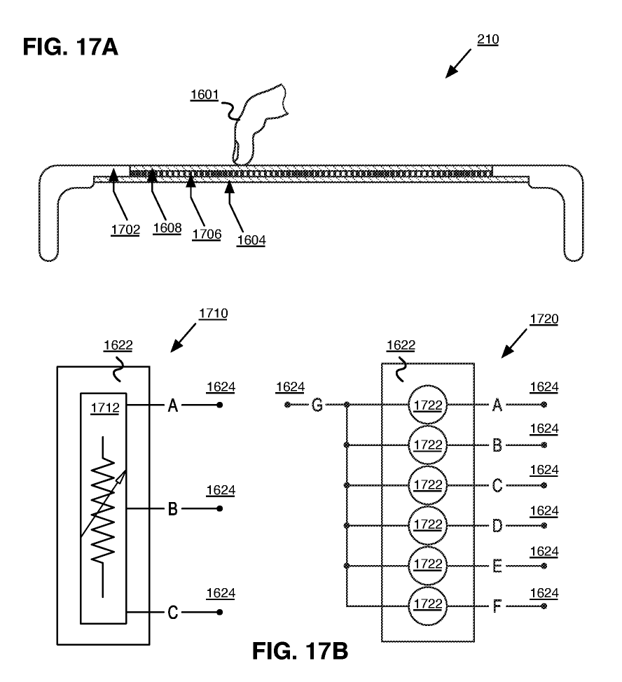

FIGS. 17A-17B show examples of touch sensing surfaces using resistive touch-sensing technology, consistent with some embodiments of the invention. As illustrated in the example in FIG. 17A, resistive touch-sensing surfaces may use a pressure sensitive device (or devices) to determine touch. Resistive touch-sensing technology requires the user physically contact the touch-sensitive device and, as such, appropriate sensors must be placed on the exterior surface of the device. As shown in FIG. 17A, a resistive touch-sensing implementation of a touch-sensitive surface 210 may include an enclosure 1702 (e.g., the housing of device 100), insulating overlay 1608, force-sensitive material 1706 (which may comprise one or more pressure sensitive contacts 1722 or pressure-sensitive sensor 1712), and insulating substrate 1604.

In certain embodiments, as shown in FIG. 17B, resistive touch-sensing implementations can be realized via a single linear pressure-sensitive resistor (configuration 1710) or a series of discrete pressure sensitive resistors (configuration 1720). A linear pressure-sensitive resistor (e.g., pressure-sensitive sensor 1712) may provide a continuous determination of the location of a touch event, whereas a series of discrete pressure-sensitive resistors (e.g., pressure-sensitive contacts 1722) may provide discrete locations of a touch event such that intermediate locations must be determined by extrapolation. Pressure-sensitive devices typically vary their resistance based on the location of the touch. The resistance change may be determined by applying a constant voltage and measuring the resultant voltage via an analog-digital converter.

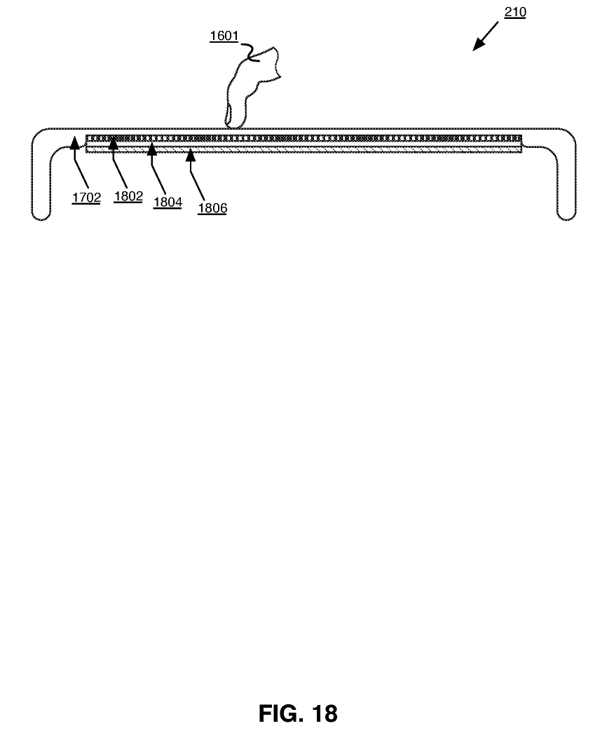

FIG. 18 is a diagram illustrating an inductive touch sensing implementation of a touch-sensitive surface 210, consistent with some embodiments of the invention. As illustrated in the example in FIG. 18, the inductive touch implementation is similar to the resistive touch implementation in that it requires deformation of the sensor to determine touch. As with the resistive touch implementation, the inductive touch implementation requires that the user (e.g., finger 1601) or an implement (e.g., a stylus) physically contact the touch-sensitive surface in order to determine touch. Contrary to the resistive touch implementation, the sensor(s) can be located beneath the surface of the housing/enclosure as shown. The activation force may be determined by the compliance of the surface which determines the amount of surface deformation from the touch event. As shown in FIG. 18, an inductive-touch implementation of a touch-sensitive surface 210 may include an enclosure 1702 (e.g., the housing of device 100), ferromagnetic material 1802, an air gap 1804, and inductive sensors 1806.

Inductive touch may be implemented by detecting minute changes in inductance, which can occur when the ferromagnetic material 1802 is displaced relative to the sensor coil component of inductive sensors 1806.

Inductive touch is typically implemented via a series of discrete inductance sensors 1806 which provide discrete locations of a touch event. In those circumstances, intermediate locations can be determined by extrapolation.

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

What is claimed is:

1. An apparatus having a user interface, consisting of:
a display screen;
a first rotary selection means operative in a first operational mode of the apparatus to facilitate user selection of a channel from a list of channels displayed on the display screen;
a second rotary selection means operative in the first operational mode of the apparatus to facilitate user selection of a media item from a selected channel of the list of channels for display on the display screen; and
one or more touch-sensitive surfaces located at one or more portions of a housing of the apparatus other than the display screen.

2. The apparatus of claim 1, wherein said user interface further consists of means for controlling an operation of the apparatus using a voice command.

3. The apparatus of claim 1, wherein said user interface further consists of means for controlling a first operation of the apparatus using physical gestures within a field of view of a camera of the apparatus, and means for controlling a second operation of the apparatus using voice commands.

4. An apparatus having a user interface, comprising:
a display screen;
a first rotary selector operative in a first operational mode of the apparatus to facilitate user selection of a channel from a list of channels displayed on the display screen;
a second rotary selector operative in the first operational mode of the apparatus to facilitate user selection of a first media item from a selected one of the list of channels for display on the display screen; and
one or more touch-sensitive surfaces located at one or more portions of a housing of the apparatus other than the display screen.

5. The apparatus of claim 4, wherein a first touch-sensitive surface of said one or more touch-sensitive surfaces is located at a top portion of said housing, and the first touch-sensitive surface is configured to sense changes in capacitance of a sensor associated with said first touch-sensitive surface.

6. The apparatus of claim 4, further comprising a processor coupled to said display screen, said first rotary selector, and said second rotary selector, said processor configured to cause to be displayed on the display screen, in succession, the first media item, and then a second media item upon receipt of a user input to advance to a next media item.

7. The apparatus of claim 6, wherein the user input is received by the processor via one of the one or more touch-sensitive surfaces.

8. The apparatus of claim 6, wherein the apparatus further comprises a camera communicatively coupled to the processor, the processor is configured to decode swipe gestures within a field of view of the camera into commands, and the user input is a swipe gesture detected by the camera.

9. The apparatus of claim 4, wherein the apparatus further comprises:
a processor coupled to said display screen and to receive inputs from said first rotary selector and said second rotary selector;
a camera communicatively coupled to said processor; and
an accelerometer communicatively coupled to said processor,
wherein said processor is configured to wake the apparatus from a low power consumption state and cause the first media item to be displayed on the display screen upon detecting movement using the camera or the accelerometer.

10. The apparatus of claim 4, further comprising a processor coupled to said display screen, said first rotary selector, and said second rotary selector, said processor configured to cause an application running on said apparatus to download from a media source associated with a channel selected through manipulation of said first rotary selector, a first media item and to display said first media item on said display screen, and then, in response to manipulation of said second rotary selector, to download from said media source a second media item and to display said second media item on said display screen.

11. The apparatus of claim 4, further comprising a processor coupled to said display screen, said first rotary selector, and said second rotary selector, said processor configured to cause an application running on said apparatus to display a user interface of an electronic device associated with a channel selected through manipulation of said first rotary selector.

12. A method for creating a channel for subscription by a multifunctional device, comprising:
via a user interface displayed at a client device, presenting a plurality of sources of media items in a source selection panel, and receiving from the client device a first selection of one of the plurality of sources as a selected source;
responsive to selection of the selected source, presenting via the user interface displayed at the client device, a plurality of media items available from the selected source in a media listing panel;
receiving from the client device an instruction to create the channel based on a selection of one or more of the plurality of media items, wherein the channel is a feed of selected ones of the plurality of media items arranged in a sequence;
presenting via the user interface displayed at the client device, a destination selector specifying one or more destinations for the channel, said destinations including at least a reference to the multifunctional device to be subscribed to the channel, and receiving a first selection including at least the multifunctional device via the destination selector; and
creating the channel by associating the selected one or more of the plurality of media items with a unique identifier and publishing the unique identifier to those of the one or more destinations indicated by the first selection of destinations.

13. The method of claim 12, further comprising receiving notification of the multifunctional device tuning to the channel.

14. The method of claim 12, wherein the plurality of sources of media items is presented in response to receipt of a search query and obtaining search results responsive to said search query.

15. The method of claim 12, wherein the client device is the multifunctional device.
